(19) United States
(12) Patent Application Publication
(10) Pub. No.: US 2013/0094888 A1
(43) Pub. Date: Apr. 18, 2013

(54) RECORDING MATERIAL CONVEYANCE APPARATUS AND IMAGE FORMING APPARATUS

(71) Applicant: CANON KABUSHIKI KAISHA, Tokyo (JP)

(72) Inventor: Yoko Maeshima, Suntou-gun (JP)

(73) Assignee: CANON KABUSHIKI KAISHA, Tokyo (JP)

(21) Appl. No.: 13/647,269

(22) Filed: Oct. 8, 2012

(30) Foreign Application Priority Data
Oct. 12, 2011 (JP) 2011-225106

(51) Int. Cl. G03G 15/00

(52) U.S. Cl. 399/388

(57) ABSTRACT

An image forming apparatus includes a conveyance unit configured to convey a recording material, a driving unit configured to drive the conveyance unit based on a manipulated variable corresponding to a deviation between a conveyance speed of the recording material and a target conveyance speed, and a control unit configured to change a control method for controlling the manipulated variable required to drive the driving unit according to a state in which the recording material is conveyed by the conveyance unit.

### BACKGROUND OF THE INVENTION

1. Field of the Invention

The present invention relates to an image forming apparatus that controls a driving unit configured to drive a conveyance unit, which is configured to convey a recording material.

2. Description of the Related Art

A conventional image forming apparatus has the capability of increasing or decreasing the conveyance speed of each recording material to convey recording materials at optimum intervals in image forming processing. To convey a recording material to a transfer position at ideal timing, the acceleration/deceleration control includes detecting the recording material with a sensor disposed on a conveyance path. The acceleration/deceleration control further includes obtaining a difference between the detected arrival timing of the recording material and ideal arrival timing. The acceleration/deceleration control further includes increasing or decreasing the conveyance speed in such a way as to reduce unevenness, such as advanced/delayed pickup or slippage occurring during a conveyance operation, to convey the recording material to the transfer position at ideal timing.

In general, a driving source of a recording material conveyance unit is a stepping motor or a direct current (DC) motor. The stepping motor is desirably used in feed-forward control because the stepping motor can cause an angular movement in proportion to the number of pulses of an input signal. In other words, the stepping motor is excellent in speed and position controllability compared to a DC motor used in feedback control. From the reason described above, the stepping motor is desirably employable as the driving source of the conveyance unit. On the other hand, the DC motor is a recently employed driving source for a recording material conveyance unit because the conveyance speed tends to increase and the required torque of the driving source tends to increase. For example, a conventional method discussed in Japanese Patent Application Laid-Open No. 2004-88926 includes generating an ideal profile for a driving operation, when the driving operation is performed, based on a target position and predetermined parameters, in the control of a DC motor employed as a power source for a device driving a mechanism, and controlling the driving of the DC motor according to the generated profile.

As conventionally known, when a DC motor is employed as a driving source, it is feasible to obtain a large torque. However, in an image forming apparatus, an optimum control method for controlling the conveyance speed of a recording material is variable depending on each control period in the process of conveying the recording material. Therefore, if a DC motor or a comparable driving source requiring feedback control is employed to perform conveyance control with fixed control constants in any control period, it is unfeasible to perform optimum control according to a conveyance state of the recording material. It is difficult to accurately control the conveyance speed of the recording material.

### SUMMARY OF THE INVENTION

The present invention is directed to a recording material conveyance apparatus that is capable of accurately controlling the conveyance speed of a recording material even in a case where a driving source is a DC motor or a comparable motor that requires feedback control.

According to an aspect of the present invention, an image forming apparatus includes a conveyance unit configured to convey a recording material, a driving unit configured to drive the conveyance unit based on a manipulated variable corresponding to a deviation between a conveyance speed of the recording material and a target conveyance speed, and a control unit configured to change a control method for controlling the manipulated variable required to drive the driving unit according to a state in which the recording material is conveyed by the conveyance unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a schematic configuration of an image forming apparatus according to a first exemplary embodiment of the present invention.

FIG. 2 is a block diagram illustrating a hardware configuration of the image forming apparatus according to the first exemplary embodiment of the present invention.

FIG. 3 illustrates a relationship between a recording material conveyed across a registration sensor and elapsed time.

FIG. 4 is a functional block diagram illustrating a paper feed and conveyance control unit of a central processing unit (CPU) according to the first exemplary embodiment of the present invention.

FIG. 5 is a flowchart schematically illustrating an operation that can be performed by the CPU according to the first exemplary embodiment of the present invention.

FIG. 6 is a functional block diagram illustrating a motor control unit according to the first exemplary embodiment of the present invention.

FIG. 7 is a flowchart schematically illustrating an operation that can be performed by the motor control unit according to the first exemplary embodiment of the present invention.

FIG. 8 is a timing chart illustrating a conveyance state of a recording material.

FIG. 9 is a flowchart illustrating a method for discriminating each control period in the process of conveying a recording material according to the first exemplary embodiment of the present invention.

FIG. 10 is a flowchart schematically illustrating an operation that can be performed by a control section selecting unit according to the first exemplary embodiment of the present invention.

FIG. 11 is a graph illustrating a relationship between conveyance sequence period information and control constant combination information and a relationship between the conveyance sequence period information and control unit combination information according to the first exemplary embodiment of the present invention.

FIG. 12 is a functional block diagram illustrating a paper feed and conveyance control unit according to a second exemplary embodiment of the present invention.

FIG. 13 is a graph illustrating load torque information that can be output by a conveyance sequence generation unit.

FIG. 14 is a functional block diagram illustrating a motor control unit according to the second exemplary embodiment of the present invention.

FIG. 15 is a timing chart illustrating a conveyance state of a recording material.

### DESCRIPTION OF THE EMBODIMENTS

Various exemplary embodiments, features, and aspects of the invention will be described in detail below with reference to the drawings.

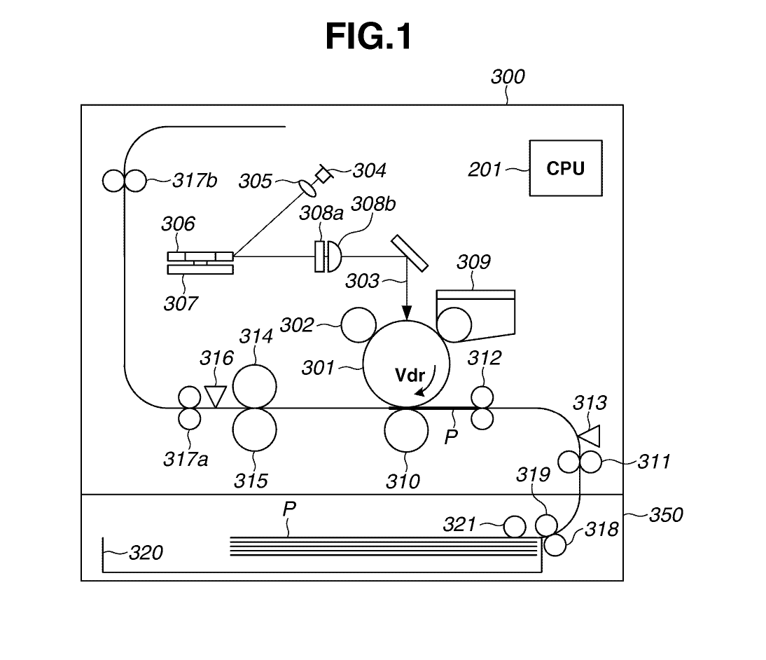

FIG. 1 illustrates a schematic configuration of an image forming apparatus according to a first exemplary embodiment. An example of the image forming apparatus described in the present exemplary embodiment is an electrographic monochrome printer. However, the image forming apparatus according to the present invention is not limited to the monochrome printer and can be a color printer or an inkjet printer.

In the image forming apparatus 300 illustrated in FIG. 1, a central processing unit (CPU) 201 can control sensors and motors and can control various operations to be performed by the image forming apparatus 300. A photosensitive drum 301 is a member capable of carrying an electrostatic latent image. A charging roller 302, which is capable of uniformly charging the surface of the photosensitive drum 301, is provided at an upper portion around the photosensitive drum 301. The charging roller 302 has a surface that is brought into contact with the surface of the photosensitive drum 301. The charging roller 302 can charge the surface of the photosensitive drum 301. A light-emitting unit can irradiate the charged surface of the photosensitive drum 301 with a light beam 303. The light-emitting unit includes the following members. A semiconductor laser 304 can emit the light beam 303. A collimator lens 305 can polarize the semiconductor laser 304 into parallel light. A polygonal mirror 306 can scan the surface of the photosensitive drum 301 with the light beam 303. An optical lens 308a can adjust the light beam 303 in such a way as to form a spot on the surface of the photosensitive drum 301. A cylindrical lens 308b can form a linear image of the parallel light on the photosensitive drum 301. A scanner motor 307 can drive the polygonal mirror 306 in such a way as to rotate at a constant speed.

An electrostatic latent image can be formed on the surface of the photosensitive drum 301 by irradiating the surface with the light beam 303 based on image data of the image to be formed. The circumferential speed of the photosensitive drum 301 in this case is referred to as an image formation speed Vdr. The electrostatic latent image can be developed into a toner image by a developing device 309, which is brought into contact with the photosensitive drum 301 on the downstream side of an irradiation position of the light beam 303 in the rotational direction of the photosensitive drum 301. The toner image can be transferred onto a recording material P (e.g., paper) by a transfer roller 310, which is disposed in a confronting relationship with the photosensitive drum 301.

The recording material P is stored in a recording material cassette 320 that is provided in a paper feeding unit 350 positioned on the upstream side of the photosensitive drum 301 at the lower side of the apparatus body. Further, the recording material P can be stored in a manual insertion tray (not illustrated). A paper feeding roller 321 is disposed at an edge portion of the recording material cassette 320. The paper feeding roller 321 can move (cause a swing motion) in the up-and-down direction while it rotates around its rotational axis. The paper feeding roller 321 can perform a pickup operation for the recording material P stored in the recording material cassette 320. A feed roller 319 and a retard roller 318 cooperatively feed only one (the uppermost) sheet of the recording material P to a conveyance path.

A pair of registration rollers 312 is disposed on a conveyance path extending from a pair of conveyance rollers 311 to the transfer roller 310. The registration rollers 312 can correct the skew of the recording material P and can synchronize image forming timing of the photosensitive drum 301 with conveyance timing of the recording material P. The registration rollers 312 can feed the recording material P to a transfer position, which is formed by the photosensitive drum 301 and the transfer roller 310, at predetermined timing. A registration sensor 313, i.e., a registration paper presence detecting sensor, is disposed between the registration rollers 312 and the conveyance rollers 311. The registration sensor 313 can detect the recording material P.

The toner image formed on the photosensitive drum 301 can be transferred to the recording material P at the transfer position. Then, the recording material P can be conveyed to a fixing device disposed on the downstream side of the photosensitive drum 301. The fixing device includes a fixing roller 314 and a pressing roller 315 that are disposed in a mutually press-contacting state. The fixing roller 314 includes a fixing heater (not illustrated) provided in its body. The fixing heater can heat the recording material P on which the toner image has been transferred when the recording material P is conveyed to a press-contact portion between the fixing roller 314 and the pressing roller 315. As a result, the toner image can be fixed on the recording material P. A discharge sheet presence detection sensor 316, which is capable of confirming the recording material P conveyed from the press-contact portion, is disposed on the downstream side of the fixing device. A pair of discharge rollers 317a and a pair of discharge rollers 317b are disposed on the downstream side of the discharge sheet presence detection sensor 316. The discharge rollers 317a and 317b can cooperatively discharge the fixed recording material P to a discharge tray.

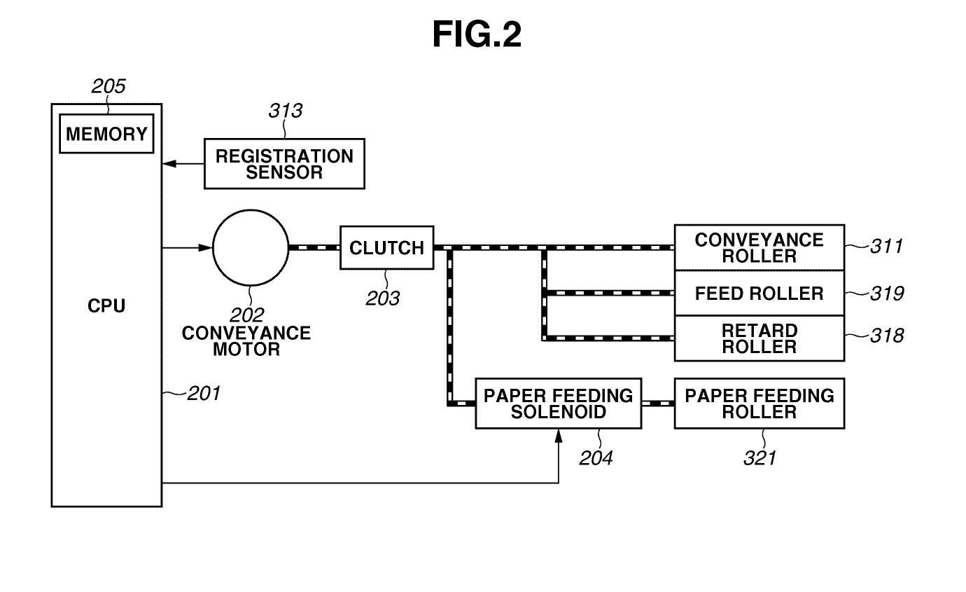

FIG. 2 is a block diagram illustrating a hardware configuration of the image forming apparatus 300. The central processing unit (CPU) 201 can control various operations to be performed by the image forming apparatus 300. A conveyance motor 202 is a driving source that can drive the image forming apparatus 300. The conveyance motor 202 is equipped with a sensor serving as a motor position detection unit configured to detect the present position of the motor. A clutch 203 can selectively transmit the driving force of the conveyance motor 202. A paper feeding solenoid 204 can drive the paper feeding roller 321 at a paper feeding port. A memory 205 stores programs and data that are required to execute the whole or a part of processing to be performed by the CPU 201. The conveyance rollers 311 can convey the recording material P when it is fed from the recording material cassette 320. The registration sensor 313 can detect the recording material P when the recording material P passes through a predetermined position. The retard roller 318 and the feed roller 319 can cooperatively feed the recording material P without causing any double feed. The paper feeding roller 321 can pick up the recording material P.

The CPU 201 is connected to the memory 205 via a bus (not illustrated). The CPU 201 controls operations to be performed by the image forming apparatus 300 with reference to programs and data stored in the memory 205. In the present exemplary embodiment, the memory 205 is provided in the CPU 201. However, the memory 205 can be positioned outside the CPU 201.

Next, paper feed and conveyance control that can be performed by the image forming apparatus 300 is described below. In response to a print instruction received from a controller (not illustrated), the CPU 201 performs preparation (e.g., starts driving the conveyance motor 202) to form an image. The CPU 201 brings the clutch 203 into an engaged state when a predetermined time has elapsed after the driving of the conveyance motor 202 is started. Further, the CPU 201 starts driving the conveyance rollers 311, the feed roller 319, and the retard roller 318. Subsequently, the CPU 201 activates the paper feeding solenoid 204 to drive the paper feeding roller 321. The paper feeding roller 321 picks the recording material P from the recording material cassette 320. More specifically, only one (the uppermost) sheet of the recording material P can be separated from the rest of the recording material P in the recording material cassette 320 by the feed roller 319 and the retard roller 318 that are cooperatively rotating in opposite directions. The picked up paper can be conveyed by the conveyance rollers 311.

When the registration sensor 313 detects a leading edge of the recording material P, the CPU 201 calculates a deviation amount between the position of an image formed on the photosensitive drum 301 and the position of the currently conveyed recording material P. Then, to correct the position of the recording material P in synchronization with the position of the image formed on the photosensitive drum 301, the conveyance rollers 311 perform an acceleration/deceleration operation taking a positional correction amount into consideration to correct the deviation amount. Subsequently, the conveyance rollers 311 convey the recording material P to the transfer position where the photosensitive drum 301 faces the transfer roller 310.

Next, the necessity of performing the acceleration/deceleration control for the recording material P is described below. When the feeding of sheets from the recording material cassette 320 is performed, the position of the leading edge of the recording material P at the conveyance start timing is variable depending on a state of the recording material P that is separated by the feed roller 319 and the retard roller 318. For example, immediately after sheets (recording material) are stored in the recording material cassette 320, the first sheet is not pulled forward together with a preceding sheet because there is not any preceding sheet. Therefore, the leading edge of the first sheet is substantially positioned in the recording material cassette 320. On the other hand, the second sheet of the recording material P is somewhat pulled forward together with the first sheet in accordance with the conveyance (feeding) of the first sheet. Thus, the second sheet of the recording material P is separated together with the first sheet by the retard roller 318 and the feed roller 319. Accordingly, the leading edge of the second sheet is substantially positioned in the vicinity of the retard roller 318. Therefore, even if the conveyance of each recording material P is performed at the same speed, the recording material P will differently reach the transfer position (i.e., the contact point between the photosensitive drum 301 and the transfer roller 310). The CPU 201 acquires elapsed time T1 from the registration sensor 313. The elapsed time T1 indicates the timing the leading edge of the recording material P has reached the predetermined position while the recording material P is conveyed by the conveyance rollers 311.

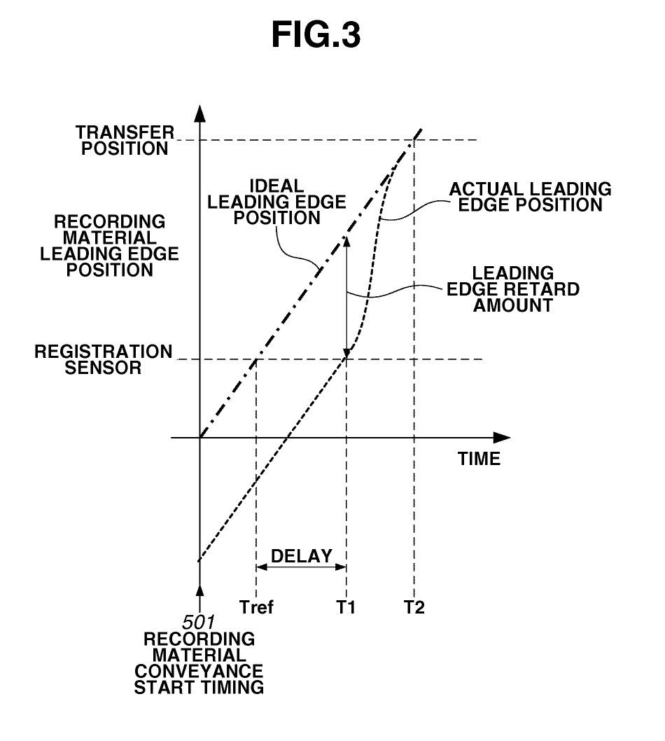

FIG. 3 illustrates example control that can be performed in a case where the elapsed time T1 (i.e., the timing the recording material P has arrived at the registration sensor 313) is later than ideal time Tref. In FIG. 3, the abscissa axis represents the elapsed time and the ordinate axis represents the leading edge position of the recording material P. The conveyance of the recording material P starts at recording material conveyance start timing 501. In FIG. 3, a dotted line indicates the trajectory of the actual leading edge position of the recording material P before the recording material P reaches the registration sensor 313. An alternate long and short dash line indicates the trajectory of the ideal leading edge position of the recording material P. A difference between the elapsed time T1 (i.e., the timing the actual leading edge of the recording material P has reached the registration sensor 313) and the ideal time Tref represents a time delay with respect to the leading edge of the recording material P. A leading edge retard amount of the recording material P can be calculated based on the conveyance speed at this moment. It is necessary to increase the conveyance speed of the recording material P in such a way as to eliminate the retard amount and gradually equalize the actual leading edge position of the recording material P with the ideal leading edge position of the recording material P, and cause the recording material P to finally reach the transfer position at ideal elapsed time T2.

Further, although not illustrated in FIG. 3, if the elapsed time T1 (i.e., the timing the recording material P has arrived at the registration sensor 313) is earlier than the ideal time Tref, the control is performed in the same manner as the above-described case. In this case, the difference between the elapsed time T1 (i.e., the timing the actual leading edge position of the recording material P has reached the registration sensor 313) and the ideal time Tref represents a time advance with respect to the leading edge of the recording material P. A leading edge advance amount of the recording material P can be calculated based on the conveyance speed at this moment. It is necessary to reduce the conveyance speed of the recording material P in such a way as to eliminate the advance amount and gradually equalize the actual leading edge position of the recording material P with the ideal leading edge position of the recording material P, and cause the recording material P to finally reach the transfer position at ideal elapsed time T2. As described above, the actual leading edge position of the recording material is advanced or retarded relative to the ideal leading edge position of the recording material. In the following description, it is presumed that the leading edge position of the recording material is retarded.

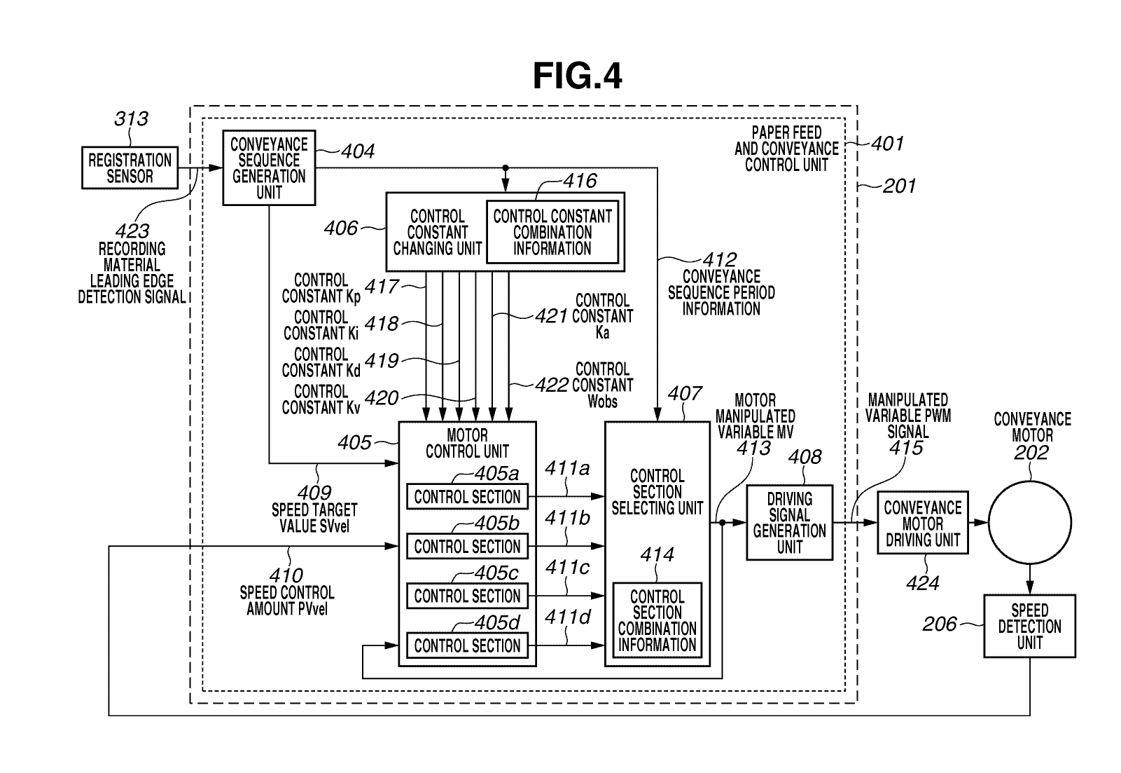

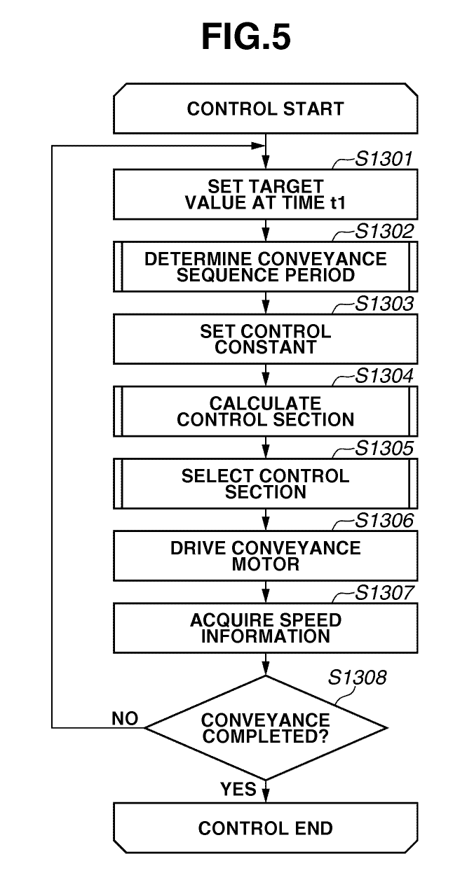

An example operation that can be performed by the CPU 201 is schematically described with reference to FIG. 4 and FIG. 5. FIG. 4 is a functional block diagram schematically illustrating a paper feed and conveyance control unit 401 of the CPU 201. FIG. 5 is a flowchart schematically illustrating an operation that can be performed by the CPU 201. Hereinafter, the operation to be performed by the CPU 201 is described below with reference to the block diagram illustrated in FIG. 4 and the flowchart illustrated in FIG. 5.

The paper feed and conveyance control unit 401 can receive input signals, such as a speed control amount PVvel 410 and a recording material leading edge detection signal 423. The paper feed and conveyance control unit 401 can output an output signal, such as a manipulated variable PWM signal 415. The paper feed and conveyance control unit 401 includes a conveyance sequence generation unit 404, a motor control unit 405, a control constant changing unit 406, a control section selecting unit 407, and a driving signal generation unit 408. In step S1301, the conveyance sequence generation unit 404 transmits a speed target value SVvel 409 to the motor control unit 405.

The speed target value SVvel 409 is a target angular speed of the conveyance motor 202. If the registration sensor 313 detects the leading edge of the recording material P, the registration sensor 313 sends the recording material leading edge detection signal 423 to the conveyance sequence generation unit 404. Instep S1302, the conveyance sequence generation unit 404 calculates the deviation amount between the position of an image already formed on the photosensitive drum 301 and the position of the currently conveyed recording material P based on the recording material leading edge detection signal 423. Then, to correct the position of the recording material P in synchronization with the position of the image formed on the photosensitive drum 301, the conveyance sequence generation unit 404 increases or decreases the speed target value SVvel 409. Further, the conveyance sequence generation unit 404 transmits conveyance sequence period information 412 to the control constant changing unit 406 and the control section selecting unit 407.

In step S1303, the control constant changing unit 406 transmits control constants 417 to 422 to the motor control unit 405. The control constant changing unit 406 changes the control constants to be supplied to the motor control unit 405 based on the conveyance sequence period information 412. The control constant changing unit 406 stores control constant combination information 416 that indicates a relationship between the conveyance sequence period information 412 and the control constants to be set. The conveyance sequence period information 412 and the control constants to be set are described in detail below. The motor control unit 405 includes a plurality of control sections 405a to 405d. The total number of the control sections that constitute the motor control unit 405 is not limited to the illustrated example. Namely, the motor control unit 405 can include an appropriate number of control sections. In step S1304, respective control sections 405a to 405d of the motor control unit 405 perform calculation processing based on the speed target value SVvel 409, the speed control amount PVvel 410, and a motor manipulated variable MV 413. The control sections 405a to 405d output calculated manipulated variables 411a to 411d, respectively. The control sections 405a to 405d are described in detail below.

In step S1305, the control section selecting unit 407 calculates the motor manipulated variable MV 413. The control section selecting unit 407 selects a combination of the control sections 405a to 405d based on the conveyance sequence period information 412. The control section selecting unit 407 calculates the motor manipulated variable MV 413 by adding only the manipulated variables corresponding to the selected combination of the control sections 405a to 405d (i.e., a part of the whole of the input manipulated variables 411a to 411d). In this case, it is desired that the control section selecting unit 407 performs weighting processing on the motor manipulated variable MV 413. For example, the control section selecting unit 407 can be configured to multiply the motor manipulated variable MV 413 by 0.9 before inputting the motor manipulated variable MV 413 to the driving signal generation unit 408. The control section selecting unit 407 includes control section combination information 414 that indicates the relationship between the conveyance sequence period information 412 and the control sections 405a to 405d to be selected. The relationship between the conveyance sequence period information 412 and the control sections 405a to 405d to be selected is described in detail below.

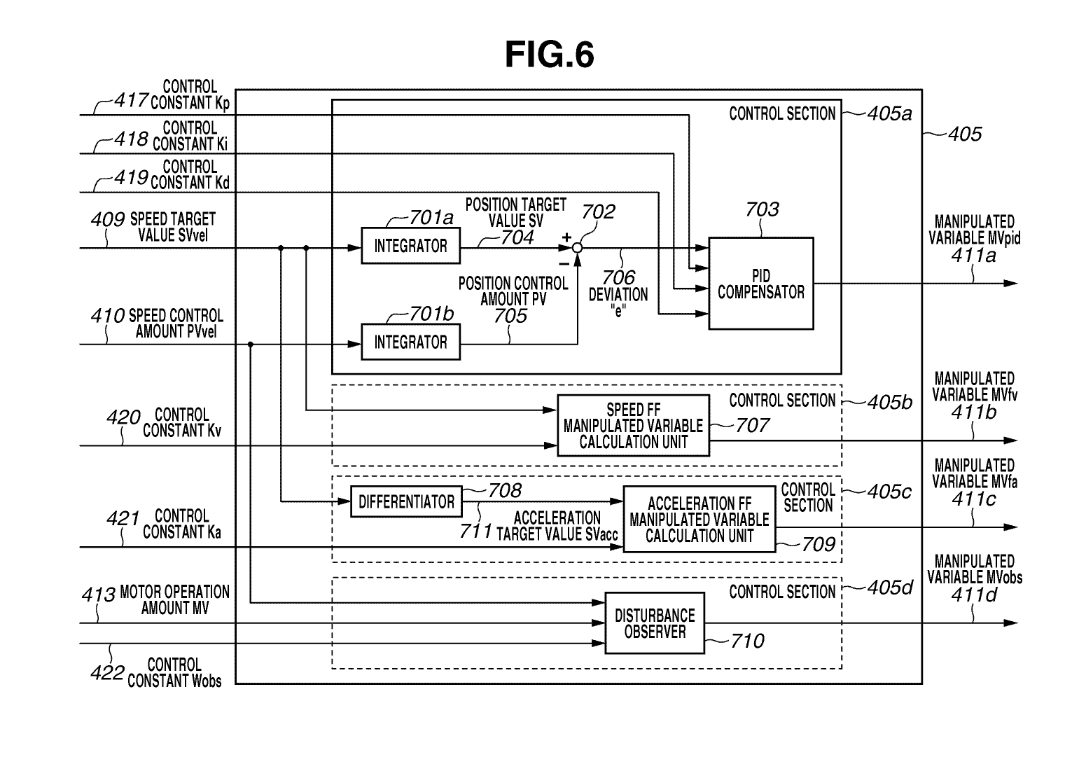

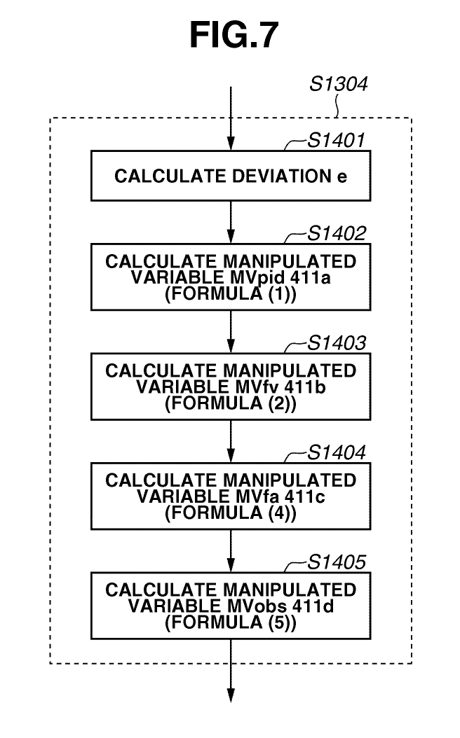

In step S1306, the driving signal generation unit 408 generates the manipulated variable PWM signal 415 having an on-duty width based on the motor manipulated variable MV 413 (i.e., the input signal). A conveyance motor driving unit 424 supplies a driving voltage to the conveyance motor 202 based on the manipulated variable PWM signal 415. The conveyance motor 202 can be driven when the driving voltage is supplied from the conveyance motor driving unit 424. In step S1307, a speed detection unit 206 detects the angular speed of the conveyance motor 202 and supplies the detected angular speed, as the speed control amount PVvel 410, to the motor control unit 405. Then, in step S1308, the CPU 201 determines whether the conveyance processing has been completed. If the conveyance processing is not yet completed (NO in step S1308), the operation returns to step S1301. If the conveyance processing has been completed (YES in step S1308), the CPU 201 terminates the control. An example operation that can be performed by the motor control unit 405 is schematically described below with reference to FIGS. 6 and 7. The motor control unit 405 includes a plurality of control sections 405a to 405d. FIG. 6 is a functional block diagram schematically illustrating the motor control unit 405. FIG. 7 is a flowchart schematically illustrating an operation that can be performed by the motor control unit 405. An example operation that can be performed by the motor control unit 405 is described with reference to the block diagram illustrated in FIG. 6 and the flowchart illustrated in FIG. 7.

The control section 405a can receive the speed target value SVvel 409, the speed control amount PVvel 410, control constant Kp 417, control constant Ki 418, and control constant Kd 419. The control section 405a can output the manipulated variable MVpid 411a. The control section 405a includes an integrator 701a, an integrator 701b, a positional deviation calculation unit 702, and a PID compensator 703. The integrator 701a can calculate a position target value SV 704 by integrating the speed target value SVvel 409. The integrator 701b can calculate a position control amount PV 705 by integrating the speed control amount PVvel 410. In step S1401, the positional deviation calculation unit 702 calculates a deviation “e” 706 between the position target value SV 704 and the position control amount PV 705. The PID compensator 703 can perform position feedback control for the conveyance motor 202. In the present exemplary embodiment, the “position” represents a cumulative phase angle of the conveyance motor 202, which is accumulated since the conveyance motor 202 is driven in response to the print instruction. In step S1402, the motor control unit 405 calculates the manipulated variable MVpid 411a (i.e., the output of the PID compensator 703) according to the following formula (1), in which Kp, Ki, and Kd represent control constants and “s” represents the Laplace operator.

$$MV pid = ( Kp + \frac{Ki}{s} + Kd s ) E \qquad ( 1 )$$

The control section 405a is a position feedback control unit, which can realize follow-up control to follow the position target value SV 704, which is variable depending on elapsed time in the present exemplary embodiment. Further, the control section 405a can switch from control highly responsive to the target value to control capable of highly suppressing the disturbance or to control indicating moderate responsiveness by selectively inputting the control constant Kp 417, the control constant Ki 418, and the control constant Kd 419. Each of the control highly responsive to the target value, the control capable of highly suppressing the disturbance, and the control indicating moderate responsiveness is described in detail below.

In the present exemplary embodiment, target value responsiveness is the responsiveness of the position control amount PV 705 that is variable depending on a change in the position target value SV 704. Accordingly, when the control highly responsive to the target value is selected, the position control amount PV 705 can promptly converge on the position target value SV 704 without causing any large overshoot when the position control amount PV 705 follows the position target value SV 704. On the other hand, disturbance suppressibility is the responsiveness of the position control amount PV 705 relative to a disturbance added to the conveyance motor 202 (i.e., a control target). Accordingly, when the control capable of highly suppressing the disturbance is selected, the deviation “e” caused when a disturbance is added to the conveyance motor 202 is small, and the position control amount PV 705 can promptly converge on the position target value SV 704.

In general, if the control capable of highly suppressing the disturbances is selected, the target value responsiveness has a tendency that it takes a long time to converge on the position target value SV 704 while causing a large overshoot, compared to the control highly responsive to the target value. Further, if the control highly responsive to the target values is selected, the disturbance suppressibility has a tendency that the deviation “e” caused when a disturbance is added to the conveyance motor 202 is large and it takes a long time to converge on the position target value SV 704, compared to the control capable of highly suppressing the disturbance. Further, if the control indicating moderate responsiveness is selected, the overshoot becomes smaller compared to that in the control highly responsive to the target value. In this case, in general, there is a tendency that it takes a long time to converge on the position target value SV 704, compared to the control highly responsive to the target value.

The control section 405b can receive the speed target value SVvel 409 and the control constant Kv 420 and can output the manipulated variable MVfv 411b. The control section 405b includes a speed feed-forward manipulated variable calculation unit 707 (hereinafter, “feed-forward” may be referred to as FF). The speed FF manipulated variable calculation unit 707 can multiply the speed target value SVvel 409 by an induced voltage constant Ke of the conveyance motor 202. Further, the speed FF manipulated variable calculation unit 707 can output the multiplied result (i.e., the value multiplied by the control constant Kv 420) to the manipulated variable MVfv 411b. The value of the induced voltage constant Ke is held in the motor control unit 405. In the present exemplary embodiment, the control constant Kv 420 and the induced voltage constant Ke are fixed values, although the constants Kv and Ke can be changed to adjust the manipulated variable MVfv 411b. The manipulated variable MVfv 411b can be obtained by multiplying a reverse voltage, which is generated when the conveyance motor 202 rotates at the speed target value SVvel 409, by the control constant Kv 420 (i.e., the gain adjustment constant). More specifically, the reverse voltage of the conveyance motor 202 can be predicted and compensated based on the manipulated variable MVfv 411b. In step S1403, the motor control unit 405b calculates the manipulated variable MVfv 411b according to the following formula (2).

MVfv=Kv×Ke×SVvel (2)

The control section 405b is a feed-forward control unit, which is configured to reduce the deviation “e” 706 between the position target value SV 704 and the position control amount PV 705 by estimating a reverse voltage generated in the conveyance motor 202 and applying the estimated reverse voltage to the conveyance motor 202. The manipulated variable MVfv 411b is usable to enhance the target value responsiveness.

The control section 405c can receive the speed target value SVvel 409 and control constant Ka 421 and can output the manipulated variable MVfa 411c. The control section 405c includes a differentiator 708 and an acceleration FF manipulated variable calculation unit 709. The differentiator 708 can differentiate the speed target value SVvel 409 and can calculate an acceleration target value SVacc 711. The acceleration FF manipulated variable calculation unit 709 can calculate a voltage value that is required to cause the conveyance motor 202 to perform an acceleration or deceleration operation according to the acceleration target value SVacc 711 based on a conveyance motor approximate model described below. Further, the acceleration FF manipulated variable calculation unit 709 can multiply the control constant Ka 421 by the calculation result and can output an obtained value as the manipulated variable MVfa 411c. In the present exemplary embodiment, the control constant Ka 421 is a fixed value, although the control constant Ka 421 can be changed to adjust the gain of the manipulated variable MVfa 411c.

The following formula (3) is a conveyance motor approximate model P(s) that represents an approximate model transfer function of the conveyance motor 202, in which the input is the voltage and the output is the angular speed. In the present exemplary embodiment, Kt represents a torque constant of the conveyance motor 202 and L represents an internal inductance of the conveyance motor 202. Further, R represents a winding resistance of the conveyance motor 202 and J represents an inertia moment of the conveyance motor 202. The Kt, L, R, and J values are prepared beforehand in the control section 405c.

$$P ( s ) = \frac{Kt}{L \cdot s + R} \frac{1}{J \cdot s} \qquad ( 3 )$$

In step S1404, the motor control unit 405c calculates the manipulated variable MVfa 411c based on the conveyance motor approximate model P(s) according to the following formula (4).

$$\begin{matrix}MV fa = Ka \frac{SV vel s}{P ( s )} \\ = Ka \frac{( L s + R ) J s}{K t} SV acc\end{matrix} \qquad ( 4 )$$

In the present exemplary embodiment, the motor control unit 405c can predict a voltage value required to cause the conveyance motor 202 to perform an acceleration or deceleration operation according to the acceleration target value SVacc 711. Then, the motor control unit 405c can apply the predicted voltage value to the conveyance motor 202 to reduce the deviation “e” 706 that may be generated between the position target value SV 704 and the position control amount PV 705. The manipulated variable MVfa 411c obtained by the acceleration feed-forward control unit can be used to enhance the target value responsiveness.

The control section 405d can receive the motor manipulated variable MV 413, the speed control amount PVvel 410, and the control constant Wobs 422. The control section 405d can output the manipulated variable MVobs 411d. The control section 405d includes a disturbance observer 710 that can perform a disturbance suppression control. The disturbance observer 710 can predict a disturbance torque applied to the conveyance motor based on the motor manipulated variable MV 413 and the speed control amount PVvel 410, and can calculate a voltage required to cancel the predicted disturbance torque. Then, the disturbance observer 710 can output the manipulated variable MVobs 411d that represents the voltage required to cancel the predicted disturbance torque. In the present exemplary embodiment, the main disturbance torque is a load torque. In step S1405, the control section 405d calculates the manipulated variable MVobs 411d based on the conveyance motor approximate model P(s) according to the following formula (5).

$$\begin{matrix}MV obs = ( \frac{Kt}{L s + R} M V - J s P V vel ) \frac{W obs}{s + W obs} \frac{1}{Kt} \\ = \frac{W obs}{s + W obs} \frac{1}{L s + R} MV - \frac{W obs}{1 + \frac{W obs}{s}} \frac{J}{Kt} PV vel\end{matrix} \qquad ( 5 )$$

The control section 405d can predict and compensate a disturbance torque added to the conveyance motor 202. The manipulated variable MVobs 411d is usable to enhance the disturbance suppressibility. Further, by changing the control constant Wobs 422, it is feasible to change the cutoff frequency of the disturbance to be suppressed and selectively perform cutoff frequency increasing control and cutoff frequency decreasing control. As described above, when the disturbance torque is predicted and compensated by the disturbance observer 710, it is feasible to reduce the deviation “e” in the feedback control. Accordingly, the time required for the feedback control can be reduced.

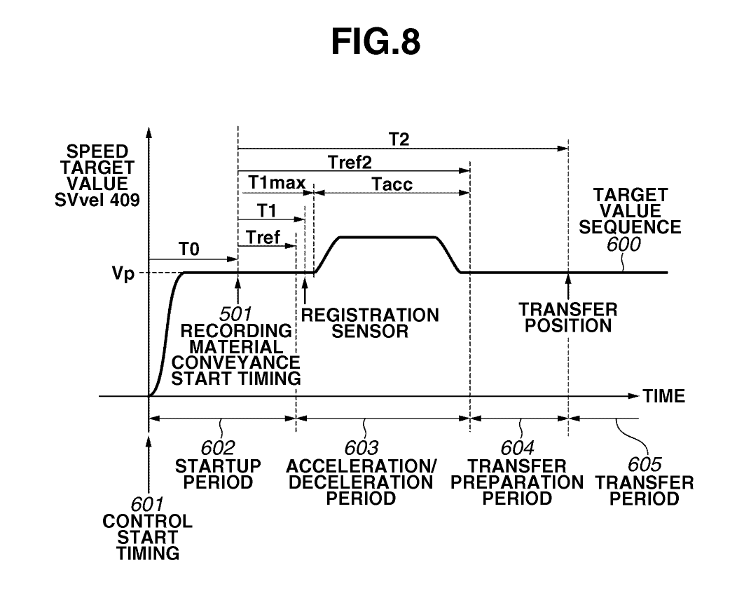

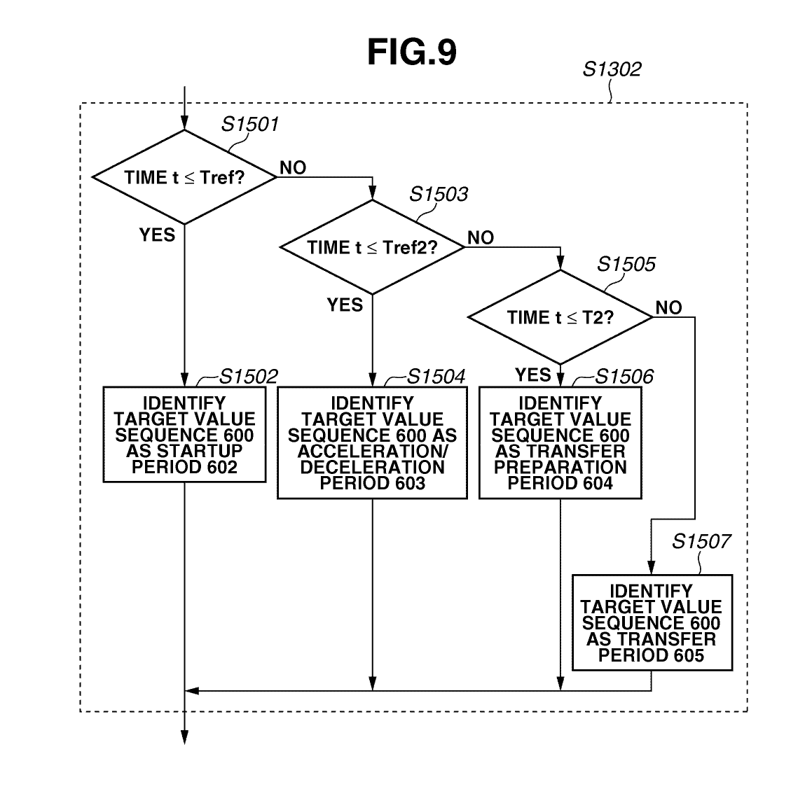

An operation that can be performed by a control system configured to control the conveyance of the recording material P is schematically described below with reference to FIGS. 8 and FIG. 9. FIG. 8 is a timing chart illustrating a conveyance state of the recording material P. FIG. 9 is a flowchart illustrating an example method for discriminating respective control periods in the process of conveying the recording material P. Hereinafter, the example operation that can be performed by the control system is described below with reference to the timing chart illustrated in FIG. 8 and the flowchart illustrated in FIG. 9. A target value sequence 600 indicates an example change of the speed target value SVvel 409 that can be generated by the conveyance sequence generation unit 404 while the time elapses. The target value sequence 600 includes four control periods divided based on operation characteristics of the target value sequence 600. The first control period is a startup period 602 during which the speed of the conveyance motor 202 is increased from a stop state until it reaches a predetermined speed. The second control period is an acceleration/deceleration period 603 during which the recording material P is accelerated or decelerated. The third control period is a transfer preparation period 604 during which the recording material P is conveyed to the transfer position at the image formation speed Vdr and at predetermined timing. The fourth control period is a transfer period 605 during which the recording material P is continuously conveyed at the image formation speed Vdr after the conveyed recording material P has reached the transfer position. The above-described four control periods are segmented according to the elapsed time, as described below.

In FIG. 8, control start timing 601 is the timing the conveyance sequence generation unit 404 starts generating the speed target value SVvel 409 in response to a print instruction received from a controller (not illustrated). The recording material conveyance start timing 501 comes after time T0 has elapsed since the control start timing 601. In the following description, the “elapsed time” is the period of time starting from the recording material conveyance start timing 501. In step S1501, the conveyance sequence generation unit 404 determines whether the time t1 is equal to or less than the predetermined elapsed time Tref. If the time t1 is equal to or less than predetermined elapsed time Tref (YES in step S1501), then in step S1502, the conveyance sequence generation unit 404 identifies the target value sequence 600 as the startup period 602. If the time t1 is greater than the time Tref (NO in step S1501) and is equal to or less than predetermined elapsed time Tref2 (YES in step S1503), then in step S1504, the conveyance sequence generation unit 404 identifies the target value sequence 600 as the acceleration/deceleration period 603. If the time t1 is greater than the time Tref2 (NO in step S1503) and is equal to or less than predetermined time T2 (YES in step S1505), then in step S1506, the conveyance sequence generation unit 404 identifies the target value sequence 600 as the transfer preparation period 604. If the time t1 is greater than the time T2 (NO in step S1505), then in step S1507, the conveyance sequence generation unit 404 identifies the target value sequence 600 as the transfer period 605. In the present exemplary embodiment, as illustrated in FIG. 3, the time Tref is the ideal time when the ideal leading edge position of the recording material is detected by the registration sensor 313. Further, as illustrated in FIG. 3, the time T1 is the time when the actual leading edge position of the recording material P is detected by the registration sensor 313. Further, as illustrated in FIG. 3, the time T2 is the time when the ideal leading edge position of the recording material P reaches the transfer position. The time Tref2 can be expressed using the following formula (6).

Tfref2=T1max+Tacc (6)

In the formula (6), T1max represents a predicted maximum delay time of T1, and Tacc represents a period of time during which the conveyance sequence generation unit 404 outputs the speed target value SVvel 409 to perform an acceleration/deceleration operation taking the positional correction amount into consideration.

The conveyance sequence generation unit 404 sends the conveyance sequence period information 412 including the present period to the control constant changing unit 406 and the control section selecting unit 407, based on the elapsed time. The definition defining the elapsed time is not limited to the above-described example. An arbitrary value can be employed. An example relationship between the conveyance sequence period information 412 and the control constant combination information 416 is described in detail below. Further, an example relationship between the conveyance sequence period information 412 and the control unit combination information 414 is described in detail below.

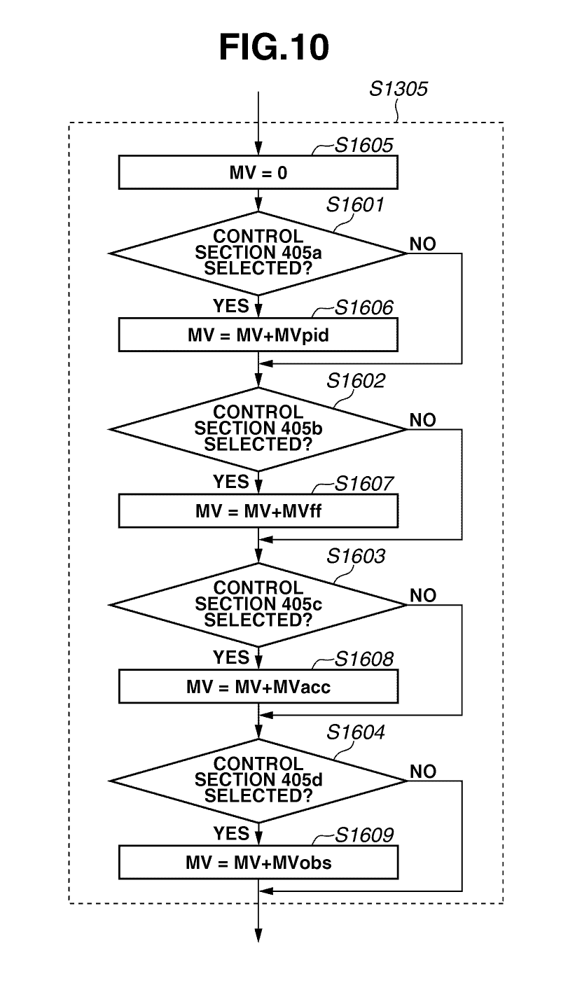

FIG. 10 is a flowchart schematically illustrating an operation that can be performed by the control section selecting unit 407. Hereinafter, an example operation that can be performed by the control section selecting unit 407 is described with reference to the timing chart illustrated in FIG. 8 and the flowchart illustrated in FIG. 10. Control information based on the combination of the control sections 405a to 405d, in the control periods notified by the conveyance sequence period information 412, is stored in the control section combination information 414. The conveyance sequence period information 412 and the combination of the control sections 405a to 405d to be selected are described below in detail.

In the startup period 602, the control section selecting unit 407 selects the control section 405a and 405b. In the acceleration/deceleration period 603, the control section selecting unit 407 selects the control sections 405a, 405b, and 405c. In the transfer preparation period 604, the control section selecting unit 407 selects the control sections 405a, 405b, and 405d. In the transfer period 605, the control section selecting unit 407 selects the control sections 405a, 405b, and 405c. In steps S1601 to S1604, the control section selecting unit 407 determines a combination of the control sections 405a to 405d to be selected based on the relationship between the conveyance sequence period information 412 and the control section combination information 414. In steps S1605 to S1609, the control section selecting unit 407 calculates the motor manipulated variable MV 413 by adding only the manipulated variables of the selected control sections. For example, in the startup period 602, if it is determined that the control section 405a is selected (YES in step S1601), then in step S1606, the control section selecting unit 407 calculates the motor manipulated variable MV 413 using a formula MV=MV+MVpid. Values of the control constants 417 to 422 in the control periods notified by the conveyance sequence period information 412 are stored in the control constant combination information 416, although numerical values of the control constants 417 to 422 are not described in detail.

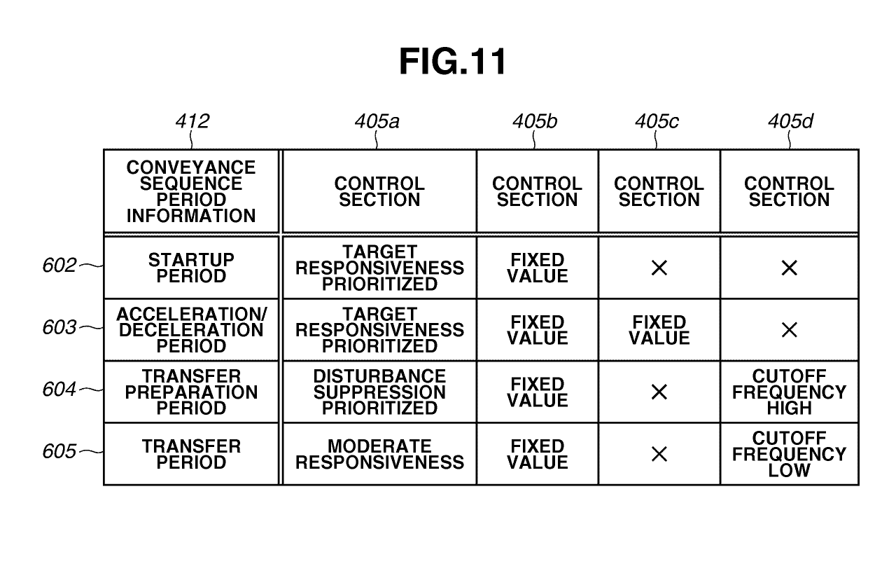

FIG. 11 is a graph illustrating an example relationship between the conveyance sequence period information 412 and the control constant combination information 416 and an example relationship between the conveyance sequence period information 412 and the control section combination information 414. In respective control periods notified by the conveyance sequence period information 412, control constant value characteristics are described in the field of respective control sections to be selected and “x” is described in the field of each non-selected control section. The setting of the control constants and the control section to be selected is a mere example and is not limited to a specific example described in the present exemplary embodiment. For example, the startup period 602 can be segmented into two periods, such as a startup period 602a and a constant speed period 602b, to precisely perform the conveyance control for the recording material P. Example control in each control period is described below with reference to FIG. 11.

The control in the startup period 602 includes increasing the speed target value SVvel 409 and starting driving the conveyance motor 202 from the stop state. The control in the startup period 602 further includes increasing the angular speed of the conveyance motor 202 until the circumferential speed of the conveyance rollers 311 reaches the image formation speed Vdr. The control further includes starting the conveyance of the recording material P. The control further includes performing control for causing the recording material P to pass through the registration sensor 313 at the image formation speed Vdr. Accordingly, the conveyance motor 202 is required to promptly reach the conveyance speed Vp after the control starts at the timing 601 and maintain the reached conveyance speed. The conveyance speed Vp is the angular speed of the conveyance motor 202, at which the circumferential speed of the conveyance rollers 311 becomes equal to the image formation speed Vdr.

Further, the deviation “e” 706 between the position target value SV 704 and the position control amount PV 705 is mainly variable depending on the speed target value SVvel 409. Accordingly, it is desired that the paper feed and conveyance control unit 401 has control characteristics excellent in target value responsiveness. In the startup period 602, the control section selecting unit 407 selects the control section 405a that can realize the follow-up control to follow the position target value SV 704 and the control section 405b that can enhance target response characteristics (see step S1601, S1606, S1602, and S1607). The startup period 602 is characteristic in that a large acceleration operation is performed in a short period of time. If the control section 405c is selected, the manipulated variable MV 413 becomes steep and the angular speed of the conveyance motor 202 may become vibratory. Therefore, the control section selecting unit 407 does not select the control section 405c (see step S1603). However, if the change of the speed target value SVvel 409 in the startup period 602 is sufficiently small, or in a case where the angular speed of the conveyance motor 202 becomes vibratory without exceeding a predetermined range, the control section selecting unit 407 can select the control section 405c. Further, the control section selecting unit 407 does not select the control section 405d because a large overshoot ay occur if the control section 405d is selected (see step S1604). However, if the control constant Wobs 422 is sufficiently small, or in a case where the overshoot does not exceed a predetermined range, the control section selecting unit 407 can select the control section 405d.

The control constant changing unit 406 sets the control constant Kp 417, the control constant Ki 418, and the control constant Kd 419 of the control section 405a in such a way as to become excellent in target value responsiveness (see step S1303). The value setting for the control constant Kp 417, the control constant Ki 418, and the control constant Kd 419 is not limited to the above-described example. Any setting of the control constants is employable if it can enhance the target value responsiveness. Performing the above-described control is effective in suppressing the overshoot that may occur when the angular speed of the conveyance motor 202 reaches the conveyance speed Vp. Further, the time required for the angular speed of the conveyance motor 202 to converge on the conveyance speed Vp can be reduced. Thus, the above-described control in the startup period 602 can reduce the time required to start the conveyance of the recording material P.

The control in the acceleration/deceleration period 603 includes detecting the leading edge position of the conveyed recording material P by the registration sensor 313 and performing acceleration/deceleration control taking a positional correction amount into consideration to correct a deviation amount in such away as to adjust the position of the recording material P in synchronization with an image formed on the photosensitive drum 301. In the acceleration/deceleration period 603, it is desired that the deviation “e” 706 is zero or small at the end of the acceleration/deceleration period 603. Further, if the speed control amount PVvel 410 is vibratory, the recording material P may slip relative to the conveyance rollers 311. There is some possibility of losing the matching between the actual leading edge position of the recording material P and the position control amount PV 705. Further, it is desired that the speed control amount PVvel 410 is not vibratory. Alternatively, it is desired that the amplitude of the vibration is small or the frequency of the vibration is low. Accordingly, similar to the startup period 602, it is desired that the paper feed and conveyance control unit 401 has control characteristics excellent in target value responsiveness. Accordingly, in the acceleration/deceleration period 603, the control section selecting unit 407 selects the control section 405a that can realize the follow-up control to follow the speed target value SVvel 409, the control section 405b that can enhance target response characteristics, and the control section 405c that can enhance target response characteristics for an acceleration/deceleration operation (see steps S1601 to S1603, and S1606 to S1608). The control section 405a performs feedback control. Therefore, the responsiveness is dependent on the interval of encoders or the pulse width of a frequency generation (FG) pulse. The responsiveness cannot be improved even if the number of times of sampling is increased beyond the interval of the encoders or the pulse width of the FG pulse.

On the other hand, the control section 405c performs feed-forward control. Therefore, the responsiveness can be increased if the number of samplings becomes larger. More specifically, if the feed-forward control is added, the control can be performed in such a way as to reduce the deviation by the feed-forward control before correcting the deviation by the feedback control. More specifically, it is feasible to improve the response to the deviation by combining the feed-forward control and the feedback control in such a way as to reduce the deviation, compared to a case where only the feedback control is performed. The control section selecting unit 407 does not select the control section 405d because the overshoot tends to become large (see step S1604). However, if the control constant Wobs 422 is sufficiently small, or in a case where the overshoot does not exceed a predetermined range, the control section selecting unit 407 can select the control section 405d. Further, similar to the startup period 602, the control constant changing unit 406 sets the control constant Kp 417, the control constant Ki 418, and the control constant Kd 419 of the control section 405a in such a way as to become excellent in target value responsiveness (see step S1303). The value setting for the control constant Kp 417, the control constant Ki 418, and the control constant Kd 419 can be performed in the same manner as the above-described setting for these constant values in the startup period 602. Any setting of the control constants is employable if it can enhance the target value responsiveness. Performing the above-described control is effective in correcting a delay or an advance of the leading edge position of the recording material P while maintaining the matching between the leading edge position of the recording material P and the position control amount PV 705.

The control in the transfer preparation period 604 includes conveying the recording material P to the transfer position at the image formation speed Vdr. It is required that the leading edge of the recording material P reaches the transfer position at the desired timing (T2). In the transfer preparation period 604, the speed target value SVvel 409 is a constant value and the deviation “e” 706 between the position target value SV 704 and the position control amount PV 705 is mainly dependent on a disturbance. Accordingly, in the transfer preparation period 604, it is desired that the paper feed and conveyance control unit 401 has control characteristics excellent in disturbance suppressibility. The above-described control in the acceleration/deceleration period 603 prioritizes the target value responsiveness to suppress the variation of the speed target value SVvel 409. However, in the transfer preparation period 604, the speed target value SVvel is constant. Accordingly, even if the control is performed in such a way as to prioritize the disturbance suppressibility, which is in a trade-off relationship with the target value responsiveness, there will be no tendency toward vibratory control. Hence, in the transfer preparation period 604, the control section selecting unit 407 selects the control section 405a that can realize the follow-up control to follow the position target value SV 704, the control section 405b that can enhance target response characteristics, and the control section 405d that can enhance the disturbance suppressibility (see steps S1601 to S1604, S1606, S1607, and S1609).

The control constant changing unit 406 changes the control constant Kp 417, the control constant Ki 418, and the control constant Kd 419 of the control section 405a in such a way as to prioritize the disturbance suppressibility over the target value responsiveness. To this end, for example, the control constant changing unit 406 sets the control constant Kp 417 to have a large value compared to the setting value in the startup period 602. The value setting for the control constant Kp 417, the control constant Ki 418, and the control constant Kd 419 is not limited to the above-described example. Any setting of the control constants is employable if it can enhance the disturbance suppressibility. Further, the control constant changing unit 406 sets the control constant Wobs 422 of the control section 405d in such a way as to have a value capable of suppressing high-frequency disturbance. In the transfer preparation period 604, ensuring the timing the recording material P arrives at the transfer position is prioritized over maintaining the conveyance speed. Setting a higher value for the control constant Wobs 422 is effective to compensate a steep disturbance torque although the angular speed of the conveyance motor 202 tends to vibrate. Accordingly, in the transfer preparation period 604, the control constant changing unit 406 sets a higher value for the control constant Wobs 422 (see step S1303). Performing the above-described control is effective in promptly correcting a delay or an advance of the leading edge position that may be caused by a disturbance while maintaining the matching between the leading edge position of the recording material P and the position control amount PV 705. Accordingly, the control can be performed in such a way as to cause the recording material P to accurately arrive at the transfer position.

The transfer period 605 is a control period in which the recording material P has already arrived at the transfer position. It is required to convey the recording material P at the image formation speed Vdr. Further, in the transfer period 605, the photosensitive drum 301 and the transfer roller 310, which are operated by a driving unit different from the conveyance motor 202, convey the recording material P at the image formation speed Vdr. Therefore, the conveyance motor 202 is required to equalize the conveyance speed Vp with the speed target value SVvel 409 and eliminate any abrupt speed variation that may induce push or pull relative to the transfer position. Therefore, it is desired to employ control that moderately responds to the deviation “e” 706 while preventing the deviation “e” 706 from occurring due to a disturbance. Accordingly, in the transfer period 605, the control section selecting unit 407 selects the control section 405a that can realize the follow-up control to follow the position target value SV 704, the control section 405b that can enhance the target value responsiveness, and the control section 405d that can enhance the disturbance suppressibility (see steps S1601 to S1604, S1606, S1607, and S1609).

The control constant changing unit 406 changes the control constant Kp 417, the control constant Ki 418, and the control constant Kd 419 of the control section 405a in such a way as to prioritize the moderate target value responsiveness over the disturbance suppressibility. To this end, for example, the control constant changing unit 406 sets the control constant Kp 417 to have a smaller value compared to the setting value in the startup period 602. The value setting for the control constant Kp 417, the control constant Ki 418, and the control constant Kd 419 is not limited to the above-described example. Any setting of the control constants is employable if it can enhance the moderate target value responsiveness. Further, the control constant changing unit 406 sets the control constant Wobs 422 of the control section 405d in such a way as to have a value lower than the value having been set in the transfer preparation period 604 (see step S1303). According to the method illustrated in FIG. 10, in step S1605, the control section selecting unit 407 sets a numerical value “0” for the manipulated variable MV 413. Alternatively, if it is desired, the control section selecting unit 407 can set a predetermined offset value. Performing the above-described control is effective in eliminating an abrupt speed change even if the conveyance speed Vp of the recording material P is changed. Therefore, it is feasible to moderately convey the recording material P as a result of suppressing the change in the conveyance speed Vp. Accordingly, the push or pull of the recording material P relative to the transfer position can be reduced.

As described above, the operation according to the exemplary embodiment includes selecting an optimum combination of control sections that is suitable for each control period in the process of conveying the recording material P. The operation further includes setting suitable control constants to perform the follow-up control in respective control periods. Compared to a case where the conveyance motor is constantly controlled by fixed control sections with uniform control constants, the operation according to the present exemplary embodiment can realize excellent control performances. For example, even in a case where a driving source is a DC motor or a comparable motor that requires feedback control, the operation according to the present exemplary embodiment can prevent deterioration in followability when acceleration/deceleration control is performed on the conveyance speed of a recording material.

As described above, the monochrome printer is a mere example to which the conveyance control according to the present exemplary embodiment is applicable. The conveyance control according to the present exemplary embodiment is also applied to a color printer or an inkjet printer. Further, a method for appropriately selecting control sections in respective control periods in the process of conveying a recording material from the paper feeding cassette to the transfer position in an image forming apparatus is not limited to the above-described example. For example, the method according to the present exemplary embodiment can be similarly applied to a recording material reading apparatus that is configured to read an image formed on the surface of a recording material, in which a recording material conveyance period is regarded as comparable to the above-described acceleration/deceleration period 603 and a recording material reading period is regarded as comparable to the above-described transfer period 605. As described above, the operation according to the present exemplary embodiment can select an optimum combination of control sections in each recording material conveyance period, not only for the image forming apparatus but also for any other apparatus configured to convey a recording material. For example, even in a case where a driving source is a DC motor or a comparable motor that requires feedback control, the operation according to the present exemplary embodiment can prevent deterioration in followability when acceleration/deceleration control is performed on the conveyance speed of a recording material.

The operation described in the first exemplary embodiment includes selecting an optimum combination of control sections that is suitable for each control period in the process of conveying the recording material P and performing the follow-up control suitable for respective control periods. In an operation according to a second exemplary embodiment, a variation in load torque due to the difference in type of each recording material P is taken into consideration. In the following description, constituent components similar to those described in the first exemplary embodiment are denoted by the same reference numerals and the descriptions thereof are not repeated.

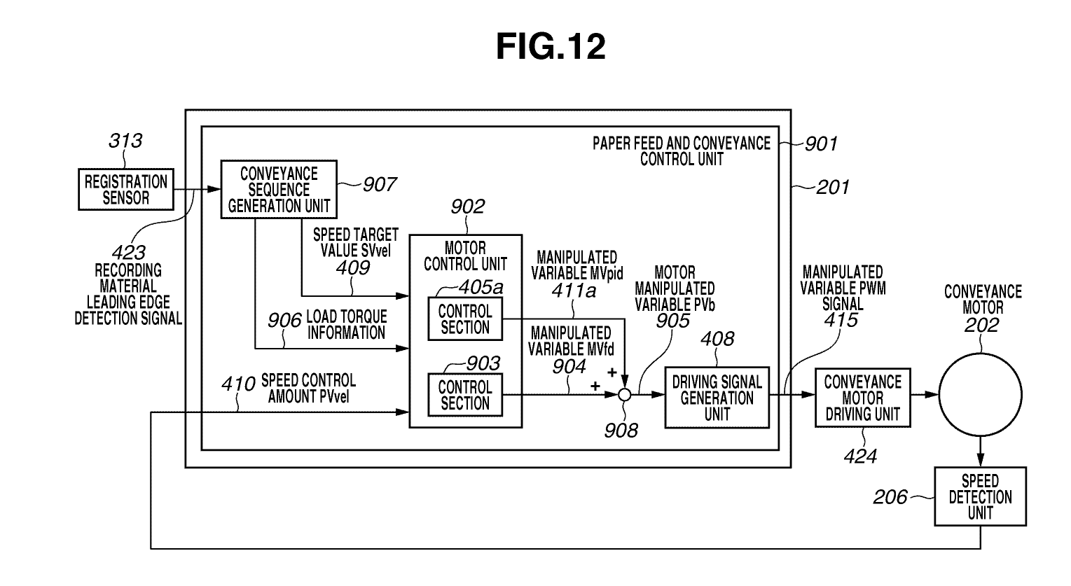

FIG. 12 is a functional block diagram schematically illustrating a paper feed and conveyance control unit 901. The paper feed and conveyance control unit 901 can receive a speed control amount PVvel 410 and a recording material leading edge detection signal 423. The paper feed and conveyance control unit 901 can output a manipulated variable PWM signal 415 based on the input signals. The paper feed and conveyance control unit 901 includes a conveyance sequence generation unit 907, a motor control unit 902, an addition device 908, and a driving signal generation unit 408. The conveyance sequence generation unit 907 can receive the recording material leading edge detection signal 423 and can output a speed target value SVvel 409 and load torque information 906. The speed target value SVvel 409 is a target angular speed of the conveyance motor 202. When a registration sensor 313 detects the leading edge of the recording material P, the registration sensor 313 sends the recording material leading edge detection signal 423 to the conveyance sequence generation unit 907.

The conveyance sequence generation unit 907 calculates a deviation amount between the position of an image already formed on the photosensitive drum 301 and the position of the currently conveyed recording material P based on the recording material leading edge detection signal 423. Then, to correct the position of the recording material P with reference to the position of the image formed on the photosensitive drum 301, the conveyance sequence generation unit 907 sends the speed target value SVvel 409 to the motor control unit 902, taking the positional correction amount into consideration to correct the deviation amount. Then, to correct the position of the recording material P with reference to the position of the image formed on the photosensitive drum 301, the conveyance sequence generation unit 907 increases or decreases the speed target value SVvel 409. Further, the conveyance sequence generation unit 907 sends the load torque information 906 to the motor control unit 902. The load torque information 906 is described in detail below. The motor control unit 902 receives the speed target value SVvel 409, the load torque information 906, and the speed control amount PVvel 410. The motor control unit 902 outputs a manipulated variable MVpid 411a and a manipulated variable MVfd 904. The addition device 908 adds the manipulated variable MVpid 411a and the manipulated variable MVfd 904 to generate a motor manipulated variable PVb 905.

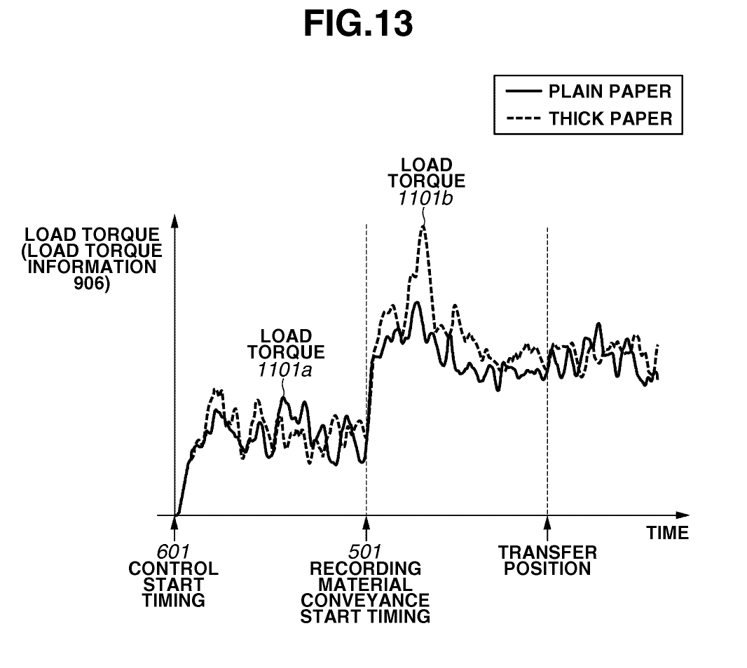

The load torque information 906 that can be generated by the conveyance sequence generation unit 907 is described below with reference to FIG. 13, in which the abscissa axis represents the elapsed time and the ordinate axis represents the load torque applied to the conveyance motor 202 in the process of conveying the recording material P. In FIG. 13, a solid line indicates a load torque 1101a applied to the conveyance motor 202 when the recording material P is plain paper and a dotted line indicates a load torque 1101b applied to the conveyance motor 202 when the recording material P is thick paper. In the present exemplary embodiment, the grammage of the plain paper (one recording material) is 75 g/m² and the grammage of the thick paper (the other recording material) is 120 g/m². The load torques 1101a and 1101b are measured beforehand and stored in the conveyance sequence generation unit 907. Further, the load torque 1101a is output from the conveyance sequence generation unit 907 as the load torque information 906 if the conveyed recording material P is plain paper and the load torque 1101b is output if the conveyed recording material P is thick paper. For example, a user can designate the type of the recording material P to be conveyed (hereinafter, the type of the recording material P may be referred to as “paper type”). A notification including the designated paper type can be transmitted to the conveyance sequence generation unit 907. Further, it is useful to additionally provide a recording material detection unit, such as an optical or ultrasonic media sensor, to detect the type of the recording material P. The illustrated load torques 1101a and 1101b are mere examples. For example, it is useful to obtain averaged load torques based on repetitively performed measurements. It is also useful to obtain approximate load torques based on the measured load torques. It is also useful to predict load torques based on the structure of the conveyance path. Further, in the present exemplary embodiment, only two paper types are prepared to simplify the description. For example, the paper type can be classified more finely in such a way as to discriminate thin paper. However, the definition of the paper types is not limited to the above-described examples. Further, adaptively using the load torque information 906 is feasible by taking environmental conditions of the image forming apparatus, such as temperature or humidity, the conveyance speed of the recording material P, or deterioration of a conveyance member that conveys the recording material P into consideration.

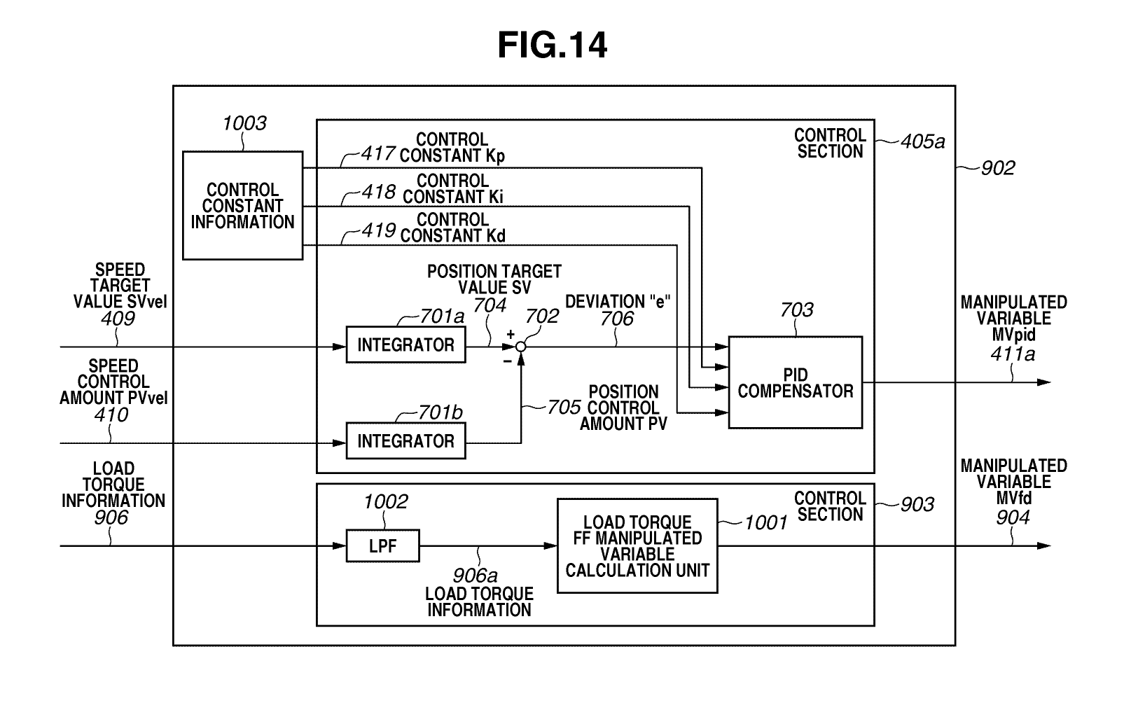

FIG. 14 is a functional block diagram schematically illustrating the motor control unit 902. The paper feed and conveyance control unit 901 includes a control section 405a, a control section 903, and control constant information 1003. The control constant information 1003 stores various values, such as control constant Kp 417, control constant Ki 418, and control constant Kd. The control constant information 1003 can be supplied to the control section 405a. Practical values of the control constants are not described in detail below.

The control section 903 can receive the load torque information 906 and can output the manipulated variable MVfd 904. The control section 903 includes a low-pass filter (referred to as “LPF”) 1002 that can perform filter processing on the load torque information 906 to generate load torque information 906a. The control section 903 further includes a load torque FF manipulated variable calculation unit 1001 that can generate a voltage value compensating the load torque information 906a and can output the generated voltage value as the manipulated variable MVfd 904. A transfer function Gτ(s) of the load torque FF manipulated variable calculation unit 1001 can be expressed using the following formula (7) based on the conveyance motor approximate model. The manipulated variable MVfd can be expressed using the following formula (8). In the present exemplary embodiment, Kt represents a torque constant of the conveyance motor 202 and L represents an internal inductance of the conveyance motor 202. Further, R represents a winding resistance of the conveyance motor 202. Kt, L, and R values are stored in the control section 903.

$$\begin{matrix}G τ ( s ) = \frac{L s + R}{Kt} & ( 7 ) \\ MV fd = G τ ( s ) \cdot ( load torque information 906 a ) & ( 8 )\end{matrix}$$

The motor control unit 902 outputs the manipulated variable MVfd 904 to predict and compensate a load torque to be applied to the conveyance motor 202. Accordingly, it becomes feasible to reduce the influence of a load torque received by the conveyance motor 202. If the load torque information 906 does not include any high-frequency component, the control section 903 can be configured to calculate the manipulated variable MVfd 904 without using the LPF 1002.

As described above, the operation according to the present exemplary embodiment includes measuring a load torque applied to the conveyance motor 202 in the process of conveying the recording material P for each type of the recording material P and storing a measurement result in the control section. The operation further includes calculating a manipulated variable in such a way as to cancel the measured load torque according to the type of the conveyed recording material P, and adding the calculated manipulated variable to the motor manipulated variable. More specifically, the operation according to the present exemplary embodiment can predict and compensate the load torque to be applied to the conveyance motor 202 in the process of conveying the recording material P. Accordingly, in the conveyance motor control, the operation according to the present exemplary embodiment can reduce the influence of the load torque applied to the conveyance motor in a paper feed and conveyance operation.

The operation described in the first exemplary embodiment includes selecting an optimum combination of control sections that is suitable for each control period in the process of conveying the recording material P and performing the follow-up control suitable for respective control periods. An operation according to a third exemplary embodiment is performed based on a method using the elapsed time and the recording material leading edge detection signal 423 in the control period of the target value sequence 600. In the following description, constituent components similar to those described in the first exemplary embodiment are denoted by the same reference numerals and the descriptions thereof are not repeated.

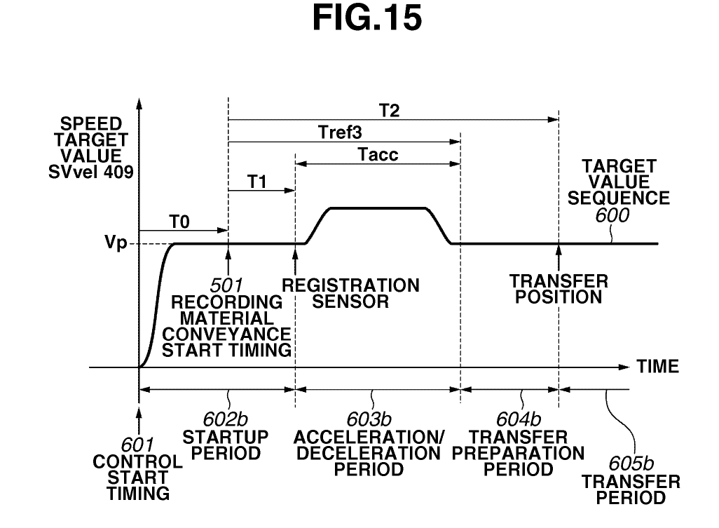

FIG. 15 is a timing chart illustrating a conveyance state of the recording material P. The paper feed and conveyance control unit 401 according to the present exemplary embodiment detects the leading edge of the recording material P based on a signal received from the registration sensor 313 and then performs acceleration/deceleration control for the conveyance motor 202. More specifically, the recording material leading edge detection signal 423 notifying the detection of the leading edge of the recording material P is a notification indicating a change point in the operation characteristics of the target value sequence 600. Accordingly, when the recording material leading edge detection signal 423 (i.e., the output of the registration sensor 313) is used in segmenting the target value sequence 600, it is feasible to accurately segment the target value sequence 600 at the change point of the operation characteristics. The operation according to the present exemplary embodiment includes segmenting the target value sequence 600 into four control periods and performing different control operations in respective control periods. The segmentation of the target value sequence 600 can be performed based on the operation characteristics. The elapsed time and the recording material leading edge detection signal 423 (i.e., an input signal from the registration sensor 313) are usable in segmenting the target value sequence 600 into a plurality of control periods.

The target value sequence 600 includes four control periods divided based on the operation characteristics. The first control period is a startup period 602b starting from the control start timing 601 and ending at the elapsed time T1 (i.e., the timing the leading edge of the recording material P is detected). The second control period is an acceleration/deceleration period 603b starting from the elapsed time T1 and ending at elapsed time Tref3. The third control period is a transfer preparation period 604b starting from the elapsed time Tref3 and ending at the elapsed time T2. The fourth control period is a transfer period 605b starting from the elapsed time T2. Further, the elapsed time Tref3 can be expressed using the following formula (9).

Tref3=T1+Tacc (9)

The conveyance control of the recording material P to be performed in respective control periods is similar to the control described in the first exemplary embodiment and, therefore, its description is not repeated.

As described above, the control period can be accurately segmented by defining control periods with reference to change points of the operation characteristics, rather than segmenting the conveyance sequence depending on only the elapsed time. Therefore, the operation according to the above-described exemplary embodiment can improve the accuracy in the conveyance control of the recording material P.

In the first exemplary embodiment, a combination of control sections selected as illustrated in FIG. 11 realizes the control for respective control periods. An operation according to a fourth exemplary embodiment includes allocating a weighting coefficient to each calculation formula for obtaining a manipulated variable of each control section and changing the coefficient for each control period, as described below. Constituent components similar to those described in the first exemplary embodiment are denoted by the same reference numerals and their descriptions are not repeated.

In the present exemplary embodiment, the manipulated variable MVpid 411a can be calculated by multiplying the formula (1) by a weighting coefficient Kpid, according to the following formula (10).

$$MV pid = K pid ( Kp + \frac{Ki}{s} + Kd s ) E \qquad ( 10 )$$

Further, the manipulated variable MVobs 411d can be calculated by multiplying the formula (5) by a weighting coefficient Kobs, according to the following formula (11).

$$MV obs = K obs ( \frac{W obs}{s + W obs} \frac{1}{L s + R} MV - \frac{W obs}{1 + \frac{W obs}{s}} \frac{J}{Kt} PV vel ) \qquad ( 11 )$$

In the present exemplary embodiment, weighting coefficients of the control section 405a, the control section 405b, the control section 405c, and the control section 405d are variable in all control periods (i.e., the startup period 602, the acceleration/deceleration period 603, the transfer preparation period 604, and the transfer period 605) to realize the setting of the control sections according to respective control periods, as described in the above-described first exemplary embodiment.

In the startup period 602, the operation according to the present exemplary embodiment sets 0 or a sufficiently small value as a value for the control constant Ka of the control section 405c and sets 0 or a sufficiently small value as a value for the control constant Kobs of the control section 405d. In the acceleration/deceleration period 603, the operation according to the present exemplary embodiment sets 0 or a sufficiently small value as a value for the control constant Kobs of the control section 405d. In the transfer preparation period 604 and the transfer period 605, the operation according to the present exemplary embodiment does not select the control section 405c. As the target value is constant, the control section 405c becomes 0 irrespective of designation of a value for the control constant Ka. Accordingly, it is unnecessary to designate any weighting coefficient in the transfer preparation period 604 and the transfer period 605. In the present exemplary embodiment, the manipulated variable selection unit 407 can be configured to output the motor manipulated variable MV 413 by adding all manipulated variables generated from respective control sections 405a to 405d.

As described above, the operation according to the present exemplary embodiment includes variably controlling weighting coefficients of respective control sections to select a combination of control sections suitable for respective control periods in the process of conveying the recording material P and setting control constants to realize the follow-up control for respective control periods. Compared to a case where the conveyance motor is constantly controlled by fixed control sections with uniform control constants, the operation according to the present exemplary embodiment can realize excellent control performances. For example, even in a case where a driving source is a DC motor or a comparable motor that requires feedback control, the operation according to the present exemplary embodiment can prevent deterioration in followability when acceleration/deceleration control is performed on the conveyance speed of a recording material.

The operation described in the first exemplary embodiment includes calculating a manipulated variable of the feed-forward control unit. In a fifth exemplary embodiment, the manipulated variable of the feed-forward control unit is stored beforehand as a profile. Constituent components similar to those described in the first exemplary embodiment are denoted by the same reference numerals and their descriptions are not repeated.

The operation according to the present exemplary embodiment includes calculating profiles of the manipulated variable MVfv 411b and the manipulated variable MVfa 411c beforehand based on a profile of the speed target value SVvel 409 and storing the calculated profiles beforehand in a memory. Further, the operation according to the present exemplary embodiment includes outputting the manipulated variable MVfv 411b and the manipulated variable MVfa 411c based on profiles of the manipulated variable MVfv 411b and the manipulated variable MVfa 411c that correspond to the profile of the speed target value SVvel 409 that can be output from the conveyance sequence generation unit 404.

The operation according to the present exemplary embodiment includes calculating the profile of the manipulated variable MVfv 411b according to the formula (2) and calculating the profile of the manipulated variable MVfa 411c according to the formula (4). Arbitrary values are usable as values of the control constant Kv 420 and the control constant Ka 421 to be used in the calculation. It is useful to prepare a plurality of profiles that can be selectively used according to an operation state. For example, it is useful to use a plurality of different sets of the control constant Kv 420 and the control constant Ka 421 to calculate profiles and store the obtained plurality of profiles in a memory. In this case, it is feasible to select appropriate profiles of the manipulated variables to be used, for example, with reference to the type of a conveyed recording material P, the environmental conditions (e.g., temperature and humidity) surrounding an image forming apparatus, the conveyance speed of the recording material P, or deterioration of a conveyance member that conveys the recording material P.

As described above, according to the present exemplary embodiment, a preliminarily calculated manipulated variable of the feed-forward control unit is stored as a manipulated variable profile in a memory and the feed-forward control can be performed without successively calculating the manipulated variable of the feed-forward control unit.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-225106 filed Oct. 12, 2011, which is hereby incorporated by reference herein in its entirety.

What is claimed is:

1. An image forming apparatus comprising:
a conveyance unit configured to convey a recording material;
a driving unit configured to drive the conveyance unit based on a manipulated variable corresponding to a deviation between a conveyance speed of the recording material and a target conveyance speed; and
a control unit configured to change a control method for controlling the manipulated variable required to drive the driving unit according to a state in which the recording material is conveyed by the conveyance unit.

2. The image forming apparatus according to claim 1, wherein the control method includes at least one control section, and
wherein the control unit is configured to select at least one control section of the control method, or to change a weighting factor applied to at least one control section, according to the state in which the recording material is conveyed, and to obtain the manipulated variable based on a value calculated for each control section.

3. The image forming apparatus according to claim 1, wherein the control method includes at least one control section, and
wherein the control unit is configured to change a coefficient of the at least one control section according to the state in which the recording material is conveyed, and to obtain the manipulated variable based on a value calculated for each control section.

4. The image forming apparatus according to claim 1, further comprising:
an image forming unit configured to form an image; and
a transfer unit configured to transfer the image formed by the image forming unit to the recording material,
wherein the control unit is configured to obtain the manipulated variable as characteristics capable of having moderate responsiveness, if any change occurs in the conveyance speed of the recording material, in feedback control that serves as one of control sections constituting the control method in a control period after the recording material has reached the transfer unit, compared to feedback control that serves as one of control sections constituting the control method in a control period before the recording material reaches the transfer unit.

5. The image forming apparatus according to claim 1, further comprising:
an image forming unit configured to form an image; and
a transfer unit configured to transfer the image formed by the image forming unit to the recording material,
wherein the control unit is configured to obtain the manipulated variable as characteristics capable of reducing cutoff frequency in such a way as to have moderate responsiveness, if any change occurs in the conveyance speed of the recording material, in a disturbance suppression control that serves as one of control sections constituting the control method in a control period after the recording material has reached the transfer unit, compared to a disturbance suppression control that serves as one of control sections constituting the control method in a control period before the recording material reaches the transfer unit.

6. The image forming apparatus according to claim 1, further comprising:
an image forming unit configured to form an image; and
a transfer unit configured to transfer the image formed by the image forming unit to the recording material,
where the control unit is configured to obtain the manipulated variable by performing feed-forward control that serves as one of control sections constituting the control method, in an acceleration/deceleration control period in which a conveyance speed target value of the recording material becomes constant before the recording material reaches the transfer unit, and to reduce a deviation between the conveyance speed of the recording material conveyed by the conveyance unit and the conveyance speed target value.

7. The image forming apparatus according to claim 6, further comprising a detection unit configured to detect the recording material conveyed by the conveyance unit,
wherein the control unit is configured to determine an acceleration/deceleration in the conveyance speed of the recording material based on a difference between a detection time when the recording material is detected by the detection unit and a target arrival time, and to determine a manipulated variable of the feed-forward control that serves as one of the control sections constituting the control method based on the acceleration/deceleration in the conveyance speed of the recording material.

8. The image forming apparatus according to claim 1, further comprising:
an image forming unit configured to form an image; and
a transfer unit configured to transfer the image formed by the image forming unit to the recording material,
wherein the control unit is configured to obtain characteristics capable of having moderate responsiveness, if any change occurs in the conveyance speed of the recording material, in feedback control that serves as one of control sections constituting the control method in a control period after the recording material has reached the transfer unit, compared to feedback control that serves as one of control sections constituting the control method in a control period before the recording material reaches the transfer unit,
wherein the control unit is configured to obtain characteristics capable of reducing cutoff frequency in such a way as to have moderate responsiveness, if any change occurs in the conveyance speed of the recording material, in disturbance suppression control that serves as one of control sections constituting the control method in a control period after the recording material has reached the transfer unit, compared to disturbance suppression control that serves as one of control sections constituting the control method in a control period before the recording material reaches the transfer unit, and
wherein the control unit is configured to obtain the manipulated variable by performing feed-forward control that serves as one of control sections constituting the control method, in an acceleration/deceleration control period in which a conveyance speed target value of the recording material becomes constant before the recording material reaches the transfer unit, and to reduce a deviation between the conveyance speed of the recording material conveyed by the conveyance unit and the conveyance speed target value.

9. The image forming apparatus according to claim 1, further comprising:
a detection unit configured to detect the recording material conveyed by the conveyance unit;
wherein the control unit is configured to determine that the state in which the recording material is conveyed is switched, in response to the detection unit detecting the recording material.

10. The image forming apparatus according to claim 1, wherein the control unit is configured to determine that the state in which the recording material is conveyed is switched, in response to a predetermined time having elapsed since the recording material starts being conveyed.

11. An image forming apparatus comprising:
a conveyance unit configured to convey a recording material;
a driving unit configured to drive the conveyance unit based on a manipulated variable corresponding to a deviation between a conveyance speed of the recording material and a target conveyance speed;
a recording material detection unit configured to detect a type of the recording material;
a storage unit configured to store a load torque applied to the driving unit; and
a control unit configured to change a control method for controlling the manipulated variable required to drive the driving unit, based on the load torque stored in the storage unit corresponding to the type of the recording material detected by the recording material detection unit.

12. A recording material conveyance apparatus comprising:
a conveyance unit configured to convey a recording material;
a driving unit configured to drive the conveyance unit based on a manipulated variable corresponding to a deviation between a conveyance speed of the recording material and a target conveyance speed; and
a control unit configured to change a control method for controlling the manipulated variable required to drive the driving unit according to a state in which the recording material is conveyed by the conveyance unit.

13. The recording material conveyance apparatus according to claim 12, wherein the control method includes at least one control section, and
wherein the control unit is configured to select at least one control section of the control method, or change a weighting factor applied to at least one control section, according to the state in which the recording material is conveyed, and to obtain the manipulated variable based on a value calculated for each control section.

14. The recording material conveyance apparatus according to claim 12, wherein the control method includes at least one control section, and
wherein the control unit is configured to change a coefficient of the at least one control section according to the state in which the recording material is conveyed, and to obtain the manipulated variable based on a value calculated for each control section.
